(19) United States
(12) Patent Application Publication
(10) Pub. No.: US 2009/0089354 A1
(43) Pub. Date: Apr. 2, 2009

(54) USER DEVICE AND METHOD AND AUTHORING DEVICE AND METHOD FOR PROVIDING CUSTOMIZED CONTENTS BASED ON NETWORK

(75) Inventors: Nac-Woo Kim, Seoul (KR); Byung-Tak Lee, Suwon (KR); Jae-Chan Shim, Daejon (KR); Ho-Young Song, Daejon (KR); Bong-Tae Kim, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications, Daejon (KR)

(21) Appl. No.: 12/146,998

(22) Filed: Jun. 26, 2008

(30) Foreign Application Priority Data
Sep. 28, 2007 (KR) 10-2007-0098148

(51) Int. Cl. G06F 15/16

(52) U.S. Cl. 709/201

(57) ABSTRACT

There is provided a user device for providing customized contents, including: a data receiving unit for receiving user multimedia data from outside; an authoring information setting unit for setting user authoring information on the user multimedia data upon a user's request; a data encoding unit for encoding the user multimedia data and the user authoring information to generate contents data; a data transmission unit for transmitting the generated contents data to a customized contents authoring device through a network; a data receiving unit for receiving authorized data transmitted from the customized contents authoring device; and a data output unit for extracting the customized contents data from the received customized data and outputting the extracted contents data.

### CROSS-REFERENCE TO RELATED APPLICATIONS

The present invention claims priority of Korean Patent Application No. 10-2007-0098148, filed on Sep. 28, 2007, which is incorporated herein by reference.

### BACKGROUND OF THE INVENTION

1. Field of the Invention

The present invention relates to a user apparatus and method and authoring apparatus and method for providing customized contents based on a network; and, more particularly, to a user device and method and authoring device and method for providing customized contents based on a network, which allow a user to easily acquire customized contents by the simple setting of the user, by transmitting multimedia data (for example, images, music, video clips, etc.) and authoring information from the user and then authoring the multimedia data into the customized contents based on the transmitted authoring information at a customized authoring device and transmitting them to the user.

2. Description of Related Art

Recently, the development of broadband network and the advent of personal blog over the Internet and bidirectional broadcasting bring abut a rapid mass production of personalized multimedia contents.

In conventional technologies of producing multimedia contents, a general user directly edits still images, video clip files, etc. obtained from a general-purpose image acquiring device by an expensive software editing device, to thus acquire processed multimedia moving image. However, most of the conventional technologies are designed in a manner that the user installs expensive software in his or her computer hardware environment and then directly produces contents.

In addition to the above technologies, there is a multimedia contents producing service that enables contents production over online. However, the multimedia contents producing service allows contents production over network online, but generally stays in the low level of homepage production or CD/DVD title production. Further, it is difficult for the general user to insert various special effects, caption, etc. to produce multimedia contents. Also, additional difficulty is that the users have to purchase costly software individually.

In addition, in order to use the existing contents authoring programs (for example, ‘Pinacle studio’, ‘Sony Vegas’, ‘Adobe Premiere’, and so on), the conventional contents authoring technology is disadvantageous that the user requires an effort and time to well know the usage of these complicated contents authoring programs. Besides, the conventional technology makes an increased effort to produce contents that meet the needs of the user by using the contents authoring programs.

Furthermore, the conventional contents authoring technology has to install expensive software in the user own computer hardware environment and then directly produce contents. Therefore, it has a drawback of installing not only the contents authoring program but also corresponding hardware separately in the user terminal, and increases a cost and effort to establish contents authoring environment.

Moreover, since the conventional contents authoring technology has to install a new authoring program or periodically update a program and hardware for a new contents authoring function, it causes the generation of an initial cost of contents authoring program as well as an additional cost and time.

### SUMMARY OF THE INVENTION

It is, therefore, an object of the present invention to provide a user device and method and authoring device and method for providing customized contents based on a network, which allow a user to easily acquire customized contents by the simple setting of the user, by transmitting multimedia data (for example, images, music, video clips, etc.) and authoring information from the user and then authoring the multimedia data into the customized contents based on the transmitted authoring information at a customized authoring device and transmitting them to the user.

In accordance with one aspect of the present invention, there is provided a user device for providing customized contents, including: a data receiving unit for receiving user multimedia data from outside; an authoring information setting unit for setting user authoring information on the user multimedia data upon a user's request; a data encoding unit for encoding the user multimedia data and the user authoring information to generate contents data; a data transmission unit for transmitting the generated contents data to a customized contents authoring device through a network; a data receiving unit for receiving authorized data transmitted from the customized contents authoring device; and a data output unit for extracting the customized contents data from the received customized data and outputting the extracted contents data.

In accordance with another aspect of the present invention, there is provided an authoring device for providing customized contents, including: a data receiving unit for receiving contents data transmitted from a customized contents user device through a network; a data analysis unit for analyzing a format of the received contents data to classify it into user multimedia data and user authoring information, and extracting metadata of the user multimedia data; a customized data encoding unit for authoring the user multimedia data based on the user authoring information to generate customized data; a metadata generation unit for generating new metadata about the customized data by using the extracted metadata and the user authoring data; a multiplexing unit for multiplexing the generated customized data and the generated metadata to generate one customized contents data; and a transmission unit for transmitting the customized contents data to the customized contents user device.

In accordance with another aspect of the present invention, there is provided a method for providing customized contents, including the steps of: a) receiving user multimedia data from outside; b) setting user authoring information on the user multimedia data upon a user's request; c) encoding the user multimedia data and the user authoring information to generate contents data; d) transmitting the generated contents data to a customized contents authoring device through a network; and e) extracting customized contents data from customized data transmitted from the customized contents authoring device and outputting the extracted customized contents data.

In accordance with another aspect of the present invention, there is provided a method for authoring customized contents, including the steps of: a) analyzing a format of contents data received transmitted from a customized contents user device through a network to classify it into user multimedia data and user authoring information, and extracting metadata of the user multimedia data; b) authoring the user multimedia data based on the user authoring information to generate customized data; c) generating new metadata on the customized data by using the extracted metadata and the user authoring data; and d) multiplexing the generated customized data and the generated metadata to generate one customized contents data, and transmitting the customized contents data to the customized contents user device.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### BRIEF DESCRIPTION OF THE DRAWINGS

FIG. 1 is a block diagram illustrating a configuration of a system for providing customized contents based on a network in accordance with a preferred embodiment of the present invention.

FIG. 2 illustrates a detailed block diagram of the customized contents user device of the present invention shown in FIG. 1.

FIG. 3 illustrates a detailed block diagram of the customized contents authoring device of the present invention shown in FIG. 1.

FIG. 4 illustrates a detailed block diagram of the customized data encoding unit of the present invention shown in FIG. 3.

FIG. 5 illustrates a flowchart describing a method for providing customized contents based on a network in a user device in accordance with another embodiment of the present invention.

FIG. 6 illustrates a flowchart describing an authoring method for providing customized contents based on a network in accordance with still another embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter, and thus, the present invention will be easily carried out by those skilled in the art. Further, in the following description, well-known arts will not be described in detail if it seems that they could obscure the invention in unnecessary detail. Hereinafter, preferred embodiments of the present invention will be set forth in detail with reference to the accompanying drawings.

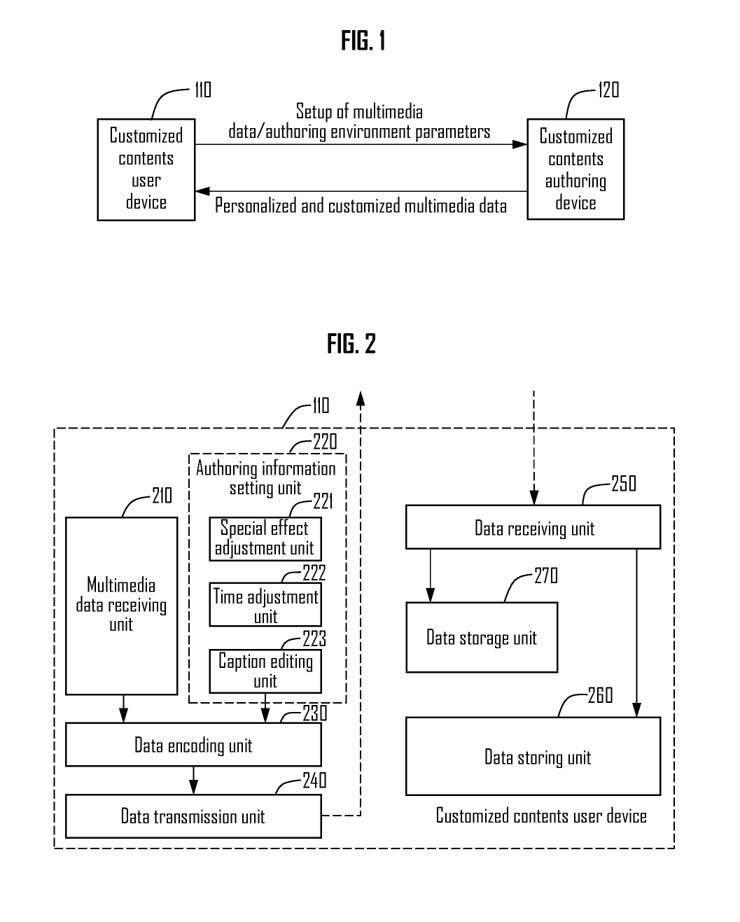

FIG. 1 is a block diagram illustrating a configuration of a system for providing customized contents based on a network in accordance with a preferred embodiment of the present invention.

As shown in FIG. 1, the system for providing customized contents based on a network of the present invention includes a customized contents user device 110 and a customized contents authoring device 120.

The customized contents user device 110 encodes user multimedia data and user authoring information together at a subscriber end and transmits the same to the customized contents authoring device 120. And, it receives customized contents data transmitted from the customized contents authoring device 120 and is browsing for the user of the subscriber end.

More specifically, the customized contents user device 110 transmits various types of user multimedia data such as music, still images and moving images to the remote customized contents authoring device 120 through a Personal Computer (PC) or a Set-Top Box (STB). By transmitting the user multimedia data obtained from an image device to the remote customized contents authoring device 120, the customized contents user device 110 receives its corresponding customized contents data from the remote customized contents authoring device 120 in real time and provides it to the user. This is to remove an inconvenience that the user of the subscriber end directly edits image products acquired from a camera or video device through a highly software and hardware unit.

At this time, the customized contents user device 110 can provide a function that selects only some options from the user and helps easily author personalized and customized contents, and also provides functions of special effect insertion, caption input, music insertion into newly authored multimedia, music removal from an existing image clip, etc.

On the other hand, the customized contents authoring device 120 authors contents data transmitted from the customized contents user device 110 into personalized and customized contents data in real time, and transmits the authored customized contents data to the customized contents user device 110 of the subscriber end. For this, the customized contents authoring device 120 edits the contents data transmitted from the customized contents user device 110 of the subscriber end to create a new multimedia file, i.e., customized contents data, and transmits the created customized contents data to the customized contents user device 110.

Further, the customized contents authoring device 120 provides functions of inserting special effects, caption, background music, etc. between objects of the contents data transmitted from the customized contents user device 110. To do so, the customized contents authoring device 120 synthesizes objects of customized data and generates metadata of the newly synthesized customized data. Also, the customized contents authoring device 120 authors customized contents and transmits them to the customized contents user device 110 (e.g., downloads streaming).

FIG. 2 illustrates a detailed block diagram of the customized contents user device of the present invention shown in FIG. 1.

As shown in FIG. 2, the customized contents user device 110 of the present invention includes a multimedia data receiving unit 210, an authoring information setting unit 220, a data encoding unit 230, a data transmission unit 240, a data receiving unit 250, a data output unit 260, and a data storage unit 270. Specifically, the authoring information setting unit 220 is provided with a special effect adjustment unit 221, a time adjustment unit 222, and a caption editing unit 223.

Hereinafter, each of the components of the customized contents user device 110 will be described in detail.

The multimedia data receiving unit 210 receives user multimedia data (e.g., still images, moving image clips, background music, etc.) obtained from various image acquiring devices (e.g., camera, video device, etc.) by the user. The user multimedia data refers to target contents objects desired to be edited by the user.

The authoring information setting unit 220 sets user authoring information on the user multimedia data to be authored by the user upon request of the user. For example, the authoring information setting unit 220 sets the special effect, caption or music of multimedia music between images desired to be inputted when authoring the user multimedia data, and user authoring information on music of image clips desired to be removed upon request of the user. At this time, the user can set the user authoring information by selecting only a plurality of options through the authoring information setting unit 220 under the browser environment. This is to readily author the customized contents (personalized multimedia contents) by the user.

Now, details of the authoring information setting unit 220 depicted in FIG. 2 will be given. First, when different user multimedia data received by the multimedia data receiving unit 210 are connected to each other, the special effect adjustment unit 221 receives information on various special effects that are based on the connection method of user multimedia data from the user.

Then, the time adjustment unit 222, when the special effects are inserted between the user multimedia data, takes time adjustment information about the time intervals of the special effects.

The caption editing unit 223 receives, from the user, caption insertion information (e.g., caption, insertion point of caption, insertion time period, etc.) to be inserted into the customized contents to be newly synthesized. That is, the user authoring information contains the special effect information, time adjustment, caption insertion information, and so on.

Meanwhile, the data encoding unit 230 encodes the user multimedia data received from the multimedia data receiving unit 210 and the authoring information set by the authoring information setting unit 220 for compression to generate contents data.

The data transmission unit 240 transmits the contents data generated by the data encoding unit 230 to the customized contents authoring device 120.

After transmitting the contents data, the customized contents authoring device 120 receives a customized data stream transmitted from the customized contents authoring device 120.

Next, the data output unit 260 decodes the customized data stream received from the data receiving unit 250 to extract customized contents data therefrom, and outputs or browses the extracted customized contents data to or for the user. The data output unit 260 can stream the customized data stream in real time and display it to the user.

At this time, the file storage unit 270 stores the customized data received from the data receiving unit 250 in its storage device upon request of the user. Further, the file storage unit 270 stores the customized data authored by the customized contents authoring device 120 in a terminal such as a user's computer, a set-top box, or the like.

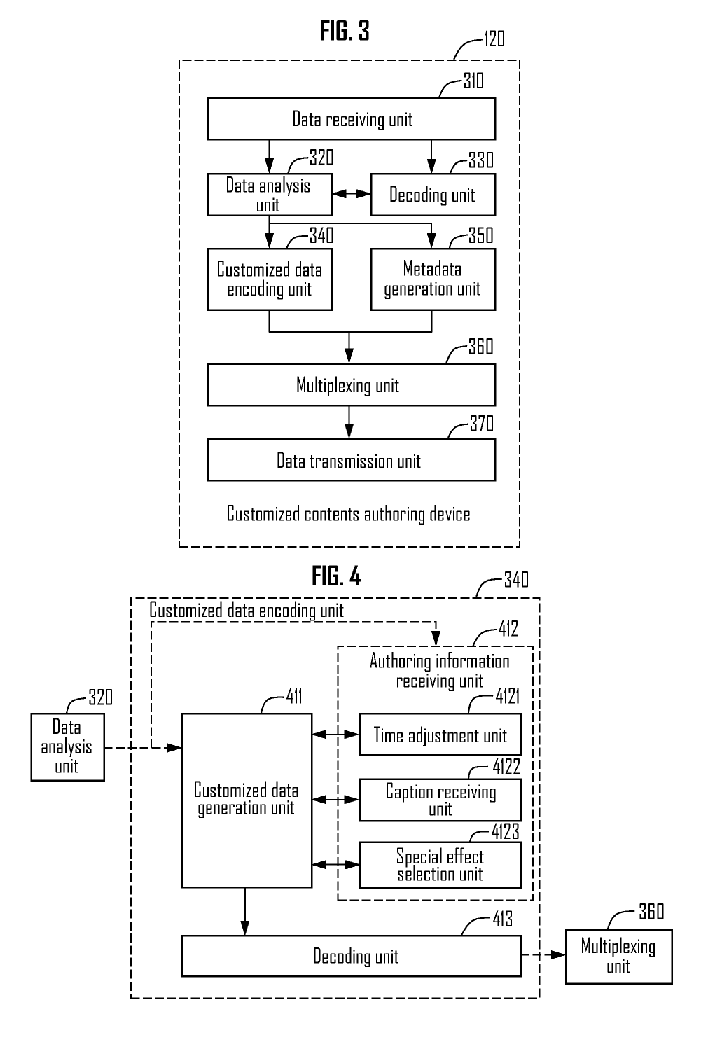

FIG. 3 illustrates a detailed block diagram of the customized contents authoring device of the present invention shown in FIG. 1.

As shown in FIG. 3, the customized contents authoring device 120 of the present invention includes a data receiving unit 310, a data analysis unit 320, a decoding unit 330, a customized data encoding unit 340, a metadata generation unit 350, a multiplexing unit 360, and a data transmission unit 370.

The data receiving unit 310 receives a contents data stream transmitted from the customized contents user device 110. The content data stream contains multimedia data and user authoring information. Here, the multimedia data may be transmitted in a format of data encoded by the customized contents user device 110 or in an object form.

The data analysis unit 320 analyzes the format of the contents data received by the data receiving unit 310 and classifies the contents data depending on the type of contents (for example, a series of still image streams, video clip streams, music streams, or the like). In addition, the data analysis unit 320 extracts metadata of the classified contents data.

The decoding unit 330 decodes the contents data received by the data receiving unit 310 based on the type of the contents when it is encoded, and delivers decoded contents data to the data analysis unit 320. For example, if the contents data is image data encoded for compression, the decoding unit 330 decodes it into non-compressed image data. And, if the contents data is moving image clip, the decoding unit 330 decodes it into image data and voice data of the moving image clip.

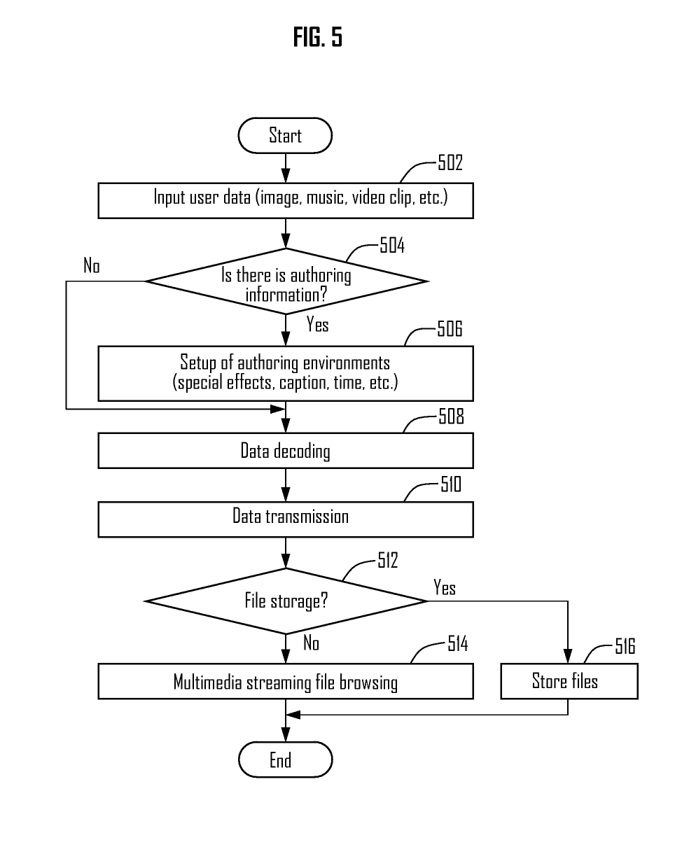

The customized data encoding unit 340 authors the contents data classified by the data analysis unit 320 on the basis of the user authoring information to generate customized data. In other words, the customized data encoding unit 340 edits the user multimedia data contained in the contents data (for example, inserts caption, music, and special effects) based on the user authoring information to encode it into customized data as one synthesized multimedia data. For example, the customized data encoding unit 340 inserts special effects, or adds or removes music or caption between the multimedia image data to synthesize them into one multimedia data. Each of the components of the customized data encoding unit 340 will be described later with reference to FIG. 4.

The metadata generation unit 350 generates metadata for new customized data by using the metadata of image extracted from the data analysis unit 320 and the user authoring information, and then encodes the generated metadata. Here, the user authoring information may contain various text data inputted by the user.

The multiplexing unit 360 multiplexes the customized data generated by the customized data encoding unit 340 and the metadata generated by the metadata generation unit 350 to provide one customized contents data.

The data transmission unit 370 transmits the customized contents data multiplexed by the multiplexing unit 360 to the customized contents user device 110. At this time, the data transmission unit 370 may transmit the customized contents data in a stream form.

FIG. 4 illustrates a detailed block diagram of the customized data encoding unit of the present invention shown in FIG. 3.

As shown in FIG. 4, the customized data encoding unit 340 includes a customized data generation unit 411, an authoring information receiving unit 412, and an encoding unit 413. Here, the authoring information receiving unit 412 is comprised of a time adjustment unit 4121, a caption receiving unit 4122, and a special effect selection unit 4123.

First, the authoring information receiving unit 412 transfers authoring information applied to the customized data encoding unit 340 to the customized data generation unit 411. Here, the authoring information receiving unit 412 takes certain authoring information arbitrarily selected from the user authoring information transmitted from the data analysis unit 320, basic authoring information basically preset in the customized contents authoring device 120, and authoring information pre-inputted to the customized contents authoring device 120, and then forwards the selected authoring information to the customized data generation unit 411.

The customized data generation unit 411 generates one customized data from various user multimedia data classified by the data analysis unit 320 by using the edition process that inserts or removes special effect, time, caption, etc. into or from the multimedia data based on the authoring information from the authoring information receiving unit 412.

For example, when the user multimedia data from the data analysis unit 320 is still images, the customized data generation unit 411 can perform the processes of inserting special effect between the still images, time setting between the images, caption insertion of frame unit, etc., and can insert background music thereinto.

In addition, if the user multimedia data from the data analysis unit 320 is moving images and background music file is contained in the authoring information according to the user's request, the customized data generation unit 411 removes the background music from each object moving image clip and synthesizes each clip image into one multimedia file, and adds the transmitted background music file to the synthesized multimedia file to generate customized data.

Further, if the background music file is not contained in the user authoring information separately and only preservation or removal option of the background music for moving image clip is selected, the customized data generation unit 411 preserves or removes the background music in or from the object moving image clip upon request thereof. Next, the customized data generation unit 411 synthesizes the multimedia moving image through the process of insertion of special effects between moving images, time setting between images, caption insertion of frame unit, etc. This synthesizing process may include the process of insertion of special effect between moving images, time setting between images, caption insertion of frame unit, etc., as in the synthesize in the still image.

Hereinafter, details of the customized data generation unit 411 will be provided. Upon synthesis of a new moving image, the caption receiving unit 4122 receives the caption insertion information on caption to be inserted from the data analysis unit 320 and delivers it to the customized data generation unit 411.

The time adjustment unit 4121 takes time adjustment information on the duration setting of special effects between images from the data analysis unit 320 and provides it to the customized data generation unit 411.

The special effect selection unit 4123 receives, from the data analysis unit 320, special effect information about insertion of special effects required for change of various scenes between images when editing different image data to be made into one, and forwards it to the customized data generation unit 411.

As mentioned above, the authoring information containing the special effect information, time adjustment information, caption insertion information, etc. means any one of user authoring information selected by the user and transmitted from the data analysis unit 320, basic authoring information basically preset at the server side, and authoring information arbitrarily selected from authoring information pre-inputted at the server side. That is, the time adjustment unit 4121, the caption receiving unit 4122, and the special effect selection unit 4123 receives the authoring information from the data analysis unit 320, basically preset authoring information, or authoring information arbitrarily selected from pre-inputted authoring information.

The encoding unit 413 encodes the customized contents generated by the customized data generation unit 411 for compression, and provides the encoded customized contents to the multiplexing unit 360.

FIG. 5 illustrates a flowchart describing a method for providing customized contents based on a network in the user device in accordance with another embodiment of the present invention.

In the method for providing customized contents in accordance with the present invention, the multimedia data receiving unit 210 receives user multimedia data (e.g., still images, moving image clips, background, and the like) acquired from various image acquiring devices (e.g., camera, video device, and the like) by the user in step S502.

Next, the authoring information setting unit 220 checks whether or not there is authoring information on the user multimedia data from the user in step S504.

As a result of checking in step S504, if there is the user authoring information, the authoring information setting unit 220 sets authoring environments (e.g., special effect, caption, and time) by using the user authoring information in step S506. On the other hand, if it is checked that there is no user authoring information, the authoring information setting unit 220 goes to step S508 for processing.

Subsequently, the data encoding unit 230 multiplexes the multimedia data from the multimedia data receiving unit 210 and the authoring information from the authoring information setting unit 220 to provide multiplexed contents data, and encodes it in step S508.

In succession, the data transmission unit 240 transmits the contents data encoded by the data encoding unit 230 to the customized contents authoring device 120 in step S510.

After transmitting the contents data, the data receiving unit 250 takes a customized data stream from the customized contents authoring device 120 and extracts customized contents data therefrom. At this time, the customized contents data may be stored in the data storage unit 270, if it is desired to be stored in step S512, in step S516.

As a result of checking in step S512, if the customized contents data is not desired to be stored, the data output unit 260 outputs the transmitted customized contents data to the user in step S514.

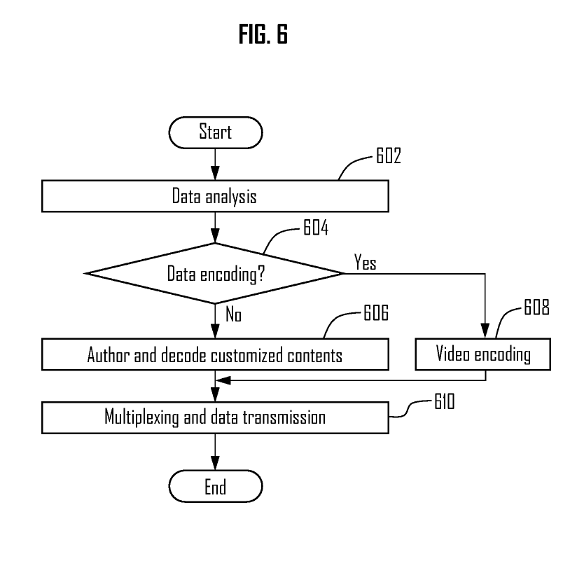

FIG. 6 illustrates a flowchart describing an authoring method for providing customized contents based on a network in the user device in accordance with still another embodiment of the present invention.

The data receiving unit 310 receives contents data transmitted from the customized contents user device 110. The contents data contains user multimedia data and user authoring information.

The data analysis unit 320 analyzes the user multimedia data in S602, and classifies the user multimedia data depending on the type of contents (e.g., a series of still image streams, video clip streams, music streams, or the like), and extract metadata on the classified user multimedia data therefrom.

Next, the data analysis unit 320 checks whether the user multimedia data is encoded or not in step S604.

If it is checked in step S604 that the user multimedia data is not encoded, the customized data encoding unit 340 authors and encodes the user multimedia data classified by the data analysis unit 320 based on the user authoring information to generate customized data in step S606. In other words, the customized data encoding unit 340 edits user multimedia object data classified by the data analysis unit 320 by using the user authoring information, wherein caption, music, and special effects are inserted, to provide one synthesized and encoded multimedia data. For example, the customized data encoding unit 340 inserts special effects between the classified multimedia image data, or synthesizes it with music or caption.

On the other hand, if it is checked in step S604 that the user multimedia data is encoded, the decoding unit 608 performs video encoding in step S608. For example, the decoding unit 608 removes a voice from the user multimedia data or extracts image clips therefrom, and then goes to step S610.

The multiplexing unit 360 multiplexes the customized data generated by the customized data encoding unit 340 and the metadata on the new customized contents data generated by the metadata generation unit 350 to provide one customized contents data, and finally, the data transmission unit 370 transmits the customized contents data multiplexed by the multiplexing unit 360 to the customized contents user device 110 in step S610.

As described above, the present invention allows a user to easily author personal creative contents at an inexpensive cost while accommodating a plurality of terminal environments, by transmitting multimedia data (e.g., images, music, video clips, etc.) and authoring information from the user and then authoring the multimedia data into customized contents based on the transmitted authoring information at a customized authoring device and transmitting them to the user.

The effects of the present invention will be described in more detail below.

Firstly, the present invention can provide contents to a user in real time by automatically executing multimedia editing at a remote server by means of simply selecting only options such as special effects, caption, background, and so on, without using an existing multimedia editing toll (e.g., Pinnacle studio, Sony Vegas, Adobe Premiere, or the like) that is difficult to use and costly, which does not require that a user knows a special image editing knowledge.

Secondly, the present invention arranges tools for contents authoring in the server environment, and thus, the present invention is operable in irrespective of hardware performance of the user terminal and the user does not need to purchase expensive software editing tools. In addition, since the present invention manages the periodic program update in the server environment, it increases a user's convenience, thereby establishing low cost, high efficient and optimal work environment.

Thirdly, the present invention allows a general user to easily produce personalized and customized contents, which offers contents based on User Created Contents (UCC) environments being popularized in recent years and also makes a large contribution to a higher value-added business.

The method of the present invention as mentioned above may be implemented by a computer program. The codes and segments constituting the computer program can be easily deduced by a computer programmer in the art. In addition, the computer program is stored in a computer-readable recoding medium (information storage medium), and read and executed by the computer, thereby implementing the method of the present invention. The recording medium may include all types of recording medium readable by the computer.

While the present invention has been described with respect to the particular embodiments, it will be apparent to those skilled in the art that various changes and modifications may be made without departing from the spirit and scope of the invention as defined in the following claims.

What is claimed is:

1. A user device for providing customized contents, comprising:
a data receiving unit for receiving user multimedia data from outside;
an authoring information setting unit for setting user authoring information on the user multimedia data upon a user's request;
a data encoding unit for encoding the user multimedia data and the user authoring information to generate contents data;
a data transmission unit for transmitting the generated contents data to a customized contents authoring device through a network;
a data receiving unit for receiving authorized data transmitted from the customized contents authoring device; and
a data output unit for extracting the customized contents data from the received customized data and outputting the extracted contents data.

2. The user device of claim 1, wherein the authoring information setting unit includes:
a special effect adjustment unit for setting special effect information on special effects with which different multimedia data is connected among the received user multimedia data upon a user's request;
a time adjustment unit for setting time adjustment information on time intervals at which the special effects are inserted upon a user's request; and
a caption editing unit for setting caption insertion information on a caption to be inserted into the user multimedia data upon a user's request.

3. The user device of claim 1, wherein the authoring information setting unit contains only authoring option information on authoring environment of the user multimedia data in the user authoring information.

4. An authoring device for providing customized contents, comprising:
a data receiving unit for receiving contents data transmitted from a customized contents user device through a network;
a data analysis unit for analyzing a format of the received contents data to classify it into user multimedia data and user authoring information, and extracting metadata of the user multimedia data;
a customized data encoding unit for authoring the user multimedia data based on the user authoring information to generate customized data;
a metadata generation unit for generating new metadata about the customized data by using the extracted metadata and the user authoring data;
a multiplexing unit for multiplexing the generated customized data and the generated metadata to generate one customized contents data; and
a transmission unit for transmitting the customized contents data to the customized contents user device.

5. The authoring device of claim 4, further comprising:
a decoding unit for decoding the received contents data if the contents data is encoded, to transfer decoded contents data to the data analysis unit.

6. The authoring device of claim 4, wherein the customized data encoding unit includes:
an authoring information receiving unit for receiving authoring information;
a customized data generation unit for authoring the user multimedia data based on the received authoring information to generate customized data; and
an encoding unit for encoding the generated customized data.

7. The authoring device of claim 6, wherein the authoring information receiving unit receives any one of the user authoring information classified by the data analysis unit, preset basic authoring information, and authoring information randomly selected from pre-inputted authoring information.

8. The authoring device of claim 6, wherein the authoring information contains special effect information, time adjustment information, and caption insertion information.

9. The authoring device of claim 6, wherein the customized data generation unit authors the user multimedia data depending on the type of each contents contained in the user multimedia data.

10. The authoring device of claim 6, wherein the customized data generation unit authors the user multimedia data by using the authoring information and predetermined authoring information contained in the user authoring information.

11. A method for providing customized contents, comprising the steps of:
a) receiving user multimedia data from outside;
b) setting user authoring information on the user multimedia data upon a user's request;
c) encoding the user multimedia data and the user authoring information to generate contents data;
d) transmitting the generated contents data to a customized contents authoring device through a network; and
e) extracting customized contents data from customized data transmitted from the customized contents authoring device and outputting the extracted customized contents data.

12. The method of claim 11, wherein the step b) includes the steps of:
b1) setting special effect information about special effects with which different multimedia data are connected among the received user multimedia data upon a user's request;
b2) setting time adjustment information on time intervals at which the special effects are inserted upon a user's request; and
b3) setting caption insertion information on a caption to be inserted into the user multimedia data upon a user's request.

13. The method of claim 11, wherein the step b) contains only authoring option information on authoring environments of the user multimedia data in the user authoring information.

14. A method for authoring customized contents, comprising the steps of:
a) analyzing a format of contents data received transmitted from a customized contents user device through a network to classify it into user multimedia data and user authoring information, and extracting metadata of the user multimedia data;
b) authoring the user multimedia data based on the user authoring information to generate customized data;
c) generating new metadata on the customized data by using the extracted metadata and the user authoring data; and
d) multiplexing the generated customized data and the generated metadata to generate one customized contents data, and transmitting the customized contents data to the customized contents user device.

15. The method of claim 14, further comprising the steps of:
e) decoding the received contents data when the contents data is encoded.

16. The method of claim 14, wherein the step b) includes the steps of:
b1) receiving authoring information containing special effect information, time adjustment information and caption insertion information;
b2) authoring the user multimedia data on the basis of the received authoring information to generate customized data; and
b3) encoding the generated customized data.

17. The method of claim 16, wherein the step b1) receives any one of the user authoring information classified in the step a), predetermined basic authoring information, and authoring information randomly selected from pre-inputted authoring information.

18. The method of claim 16, wherein the step b2) authors the user multimedia data depending on the type of each contents contained in the user multimedia data.

19. The method of claim 16, wherein the step b2) authors the user multimedia data by using the authoring option information and predetermined authoring information contained in the user authoring information.
